(19) United States
(12) Patent Application Publication
(10) Pub. No.: US 2015/0028014 A1
(43) Pub. Date: Jan. 29, 2015

(54) HEATABLE HANDLE JACKET FOR A VEHICLE

(71) Applicant: Tong Yah Electronic Technology Co., Ltd., Tainan City (TW)

(72) Inventor: PO SHUAN WANG, TAINAN CITY (TW)

(73) Assignee: Tong Yah Electronic Technology Co., Ltd., Tainan City (TW)

(21) Appl. No.: 14/039,091

(22) Filed: Sep. 27, 2013

(30) Foreign Application Priority Data
Jul. 23, 2013 (TW) 102213821

(51) Int. Cl. B62D 1/06; B62K 21/26; B62J 33/00; H05B 3/48

(52) U.S. Cl. CPC B62D 1/065; H05B 3/48; B62K 21/26; B62J 33/00
USPC 219/204; 219/535

(57) ABSTRACT

A heatable handle jacket includes a jacket mounted around a handle of a vehicle. The jacket is made of a thermally conductive material and includes an end having an outer surface with a recessed portion. A heating unit includes a heating wire mounted inside the jacket or to an inner side of the jacket. A controller is embedded in the recessed portion and electrically connected to the heating unit to control heating operation of the heating wire.

### BACKGROUND OF THE INVENTION

The present invention relates to a handle jacket for a vehicle and, more particularly, to a heatable handle jacket for a vehicle.

The hands of drivers of vehicles such as motorcycles, snowmobiles, skibobs, or the like are less nimble in cold zones. The handles of such vehicles are liable to deteriorate due to low temperatures, adversely affecting the function of the handles. To avoid these problems, the vehicles are equipped with a heatable handle jacket to provide heat through supply of electricity.

To allow easy maneuver by the driver, an annular frame is mounted around the jacket and includes three frames together defining an upwardly facing opening for receiving a controller by which the driver can control on/off of the heatable handle jacket with his or her thumb, providing enhanced maneuverability.

However, the controller must be mounted to an end of the jacket through the annular frame comprised of three frames such that the controller is apt to disengage from the jacket. Furthermore, the heatable handle jacket has many elements causing inconvenient, time-consuming assemblage. Furthermore, water is apt to enter an interior of the heatable handle jacket via gaps between the frames.

Thus, a need exists for a novel heatable handle jacket that mitigates and/or obviates the above disadvantages.

### BRIEF SUMMARY OF THE INVENTION

A heatable handle jacket according to the present invention includes a jacket adapted to be mounted around a handle of a vehicle. The jacket is made of a thermally conductive material and includes an end having an outer surface with a recessed portion. A heating unit includes a heating wire mounted inside the jacket or to an inner side of the jacket. A controller is embedded in the recessed portion and electrically connected to the heating unit to control heating operation of the heating wire.

Preferably, the controller includes a protrusion. The recessed portion includes a wall having a groove in which the protrusion is engaged.

Preferably, the controller includes a temperature indicator for indicating a temperature of the heating wire. The temperature indicator faces an opening of the recessed portion.

Preferably, the jacket includes an inner sleeve and an outer sleeve mounted around the inner sleeve. The inner sleeve is adapted to be mounted around the handle of the vehicle. The outer sleeve is made of the thermally conductive material. The heating wire is mounted between the inner and outer sleeves.

Preferably, the heating wire extends helically around the inner sleeve.

Preferably, the outer sleeve is made of an elastomeric material.

Preferably, a bonding layer is filled between the controller and the recessed portion.

By forming the recessed portion in the outer sleeve, the controller is less likely to fall off from the jacket. Furthermore, the heatable handle jacket has fewer elements than conventional heatable handle jackets, allowing easy assemblage and saving the time for assemblage and installation. Furthermore, the bonding layer avoids water from entering into a gap between the controller and the recessed portion, preventing damage while further avoiding disengagement of the controller.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a perspective view of a heatable handle jacket according to the present invention.

FIG. 2 is a partially exploded perspective view of the heatable handle jacket of FIG. 1.

FIG. 3 is a perspective view of an inner handle of the heatable handle jacket of FIG. 1.

FIG. 4 is a cross sectional view of the heatable handle jacket of FIG. 1.

### DETAILED DESCRIPTION OF THE INVENTION

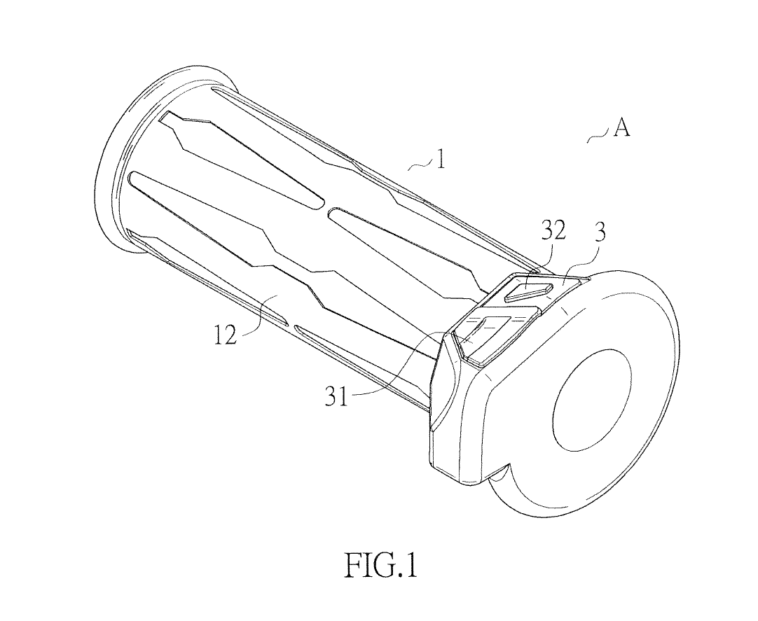

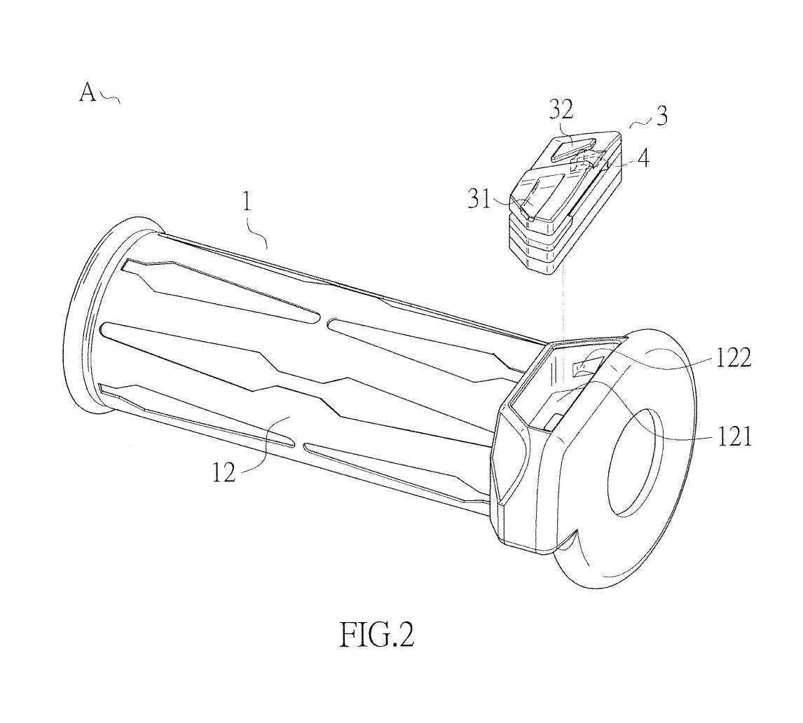

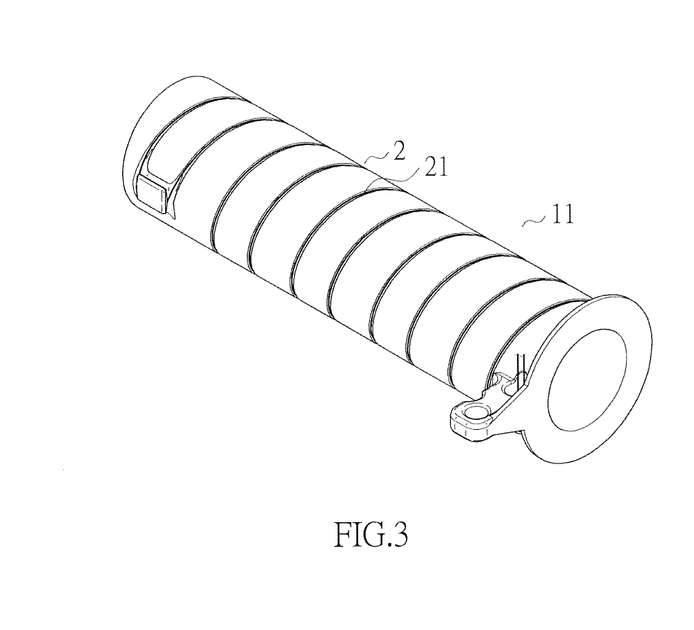

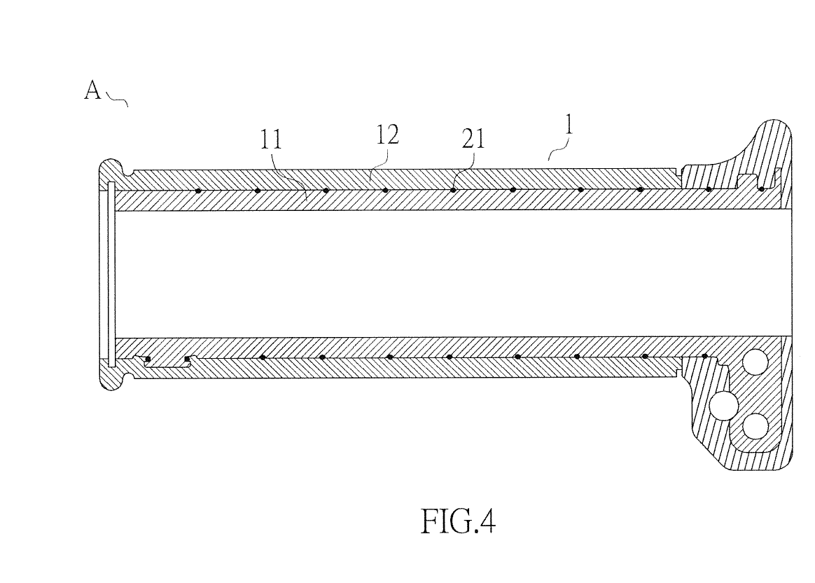

A heatable handle jacket according to the present invention is shown in FIGS. 1-4 and designated A. The heatable handle jacket A includes a jacket 1 adapted to be mounted around a handle of a vehicle, such as a motorcycle. In the form shown, the jacket 1 includes an inner sleeve 11 to be mounted around the handle of the vehicle and an outer sleeve 12 mounted around the inner sleeve 11. The outer sleeve 12 is made of a thermally conductive material. The outer sleeve 12 includes an end having an outer surface with a recessed portion 121. The recessed portion 121 includes a wall having a groove 122. The outer sleeve 12 made of elastomeric material provides the driver with a comfortable touch, which is advantageous over the conventional heatable handle jacket comprised of rigid frames.

The heatable handle jacket A further includes a heating unit 2 having a heating wire 21. The heating wire 21 is mounted inside the jacket 1 or to an inner side of the jacket 1. The inner side of the jacket 1 contacts with the handle of the vehicle after the jacket 1 is mounted around the handle of the vehicle. In the form shown, the heating wire 21 is mounted between the inner and outer sleeves 11 and 12 and preferably on an outer periphery of the inner sleeve 11. Since the outer sleeve 12 is made of a thermally conductive material, the heat can be transmitted through the heating wire 21 to the outer sleeve 12 gripped by the driver. Thus, the hands of the driver will not feel cold while driving in winter or cold weather. The heating wire 21 extends helically around the inner sleeve 11 to provide uniform heating.

The heatable handle jacket A further includes a controller 3 embedded in the recessed portion 121. The controller 3 preferably includes a protrusion 4 on an outer side thereof. The protrusion 4 is engaged in the groove 122 of the recessed portion 121, preventing the controller 3 from disengaging from the jacket 1.

The controller 3 is electrically connected to the heating unit 2. The driver can control heating operation (such as turning on or off the heating function or adjusting the temperature of the heating wire 21) by a button 31. The controller 3 further includes a temperature indicator 32 on the outer side thereof for indicating the temperature of the heating wire 21 or the jacket 1. The temperature indicator 32 faces an opening of the recessed portion such that the driver can immediately know the temperature of the heatable handle jacket A.

The temperature indicator 32 can show the driver the temperature of the heatable handle jacket A by showing a change in color. Alternatively, the temperature indicator 32 can be of digital type showing the temperature value. Other forms of temperature indicator 32 can be used.

By forming a recessed portion 121 in the outer sleeve 12, the controller 3 is less likely to fall off from the jacket 1. Furthermore, the heatable handle jacket A has fewer elements than conventional heatable handle jackets, allowing easy assemblage and saving the time for assemblage and installation. Furthermore, a bonding layer can be filled between the controller 3 and the recessed portion 121 to avoid water from entering into a gap between the controller 3 and the recessed portion 121, preventing damage while further avoiding disengagement of the controller 3.

Although specific embodiments have been illustrated and described, numerous modifications and variations are still possible without departing from the scope of the invention. The scope of the invention is limited by the accompanying claims.

1. A heatable handle jacket comprising:
a jacket adapted to be mounted around a handle of a vehicle, with the jacket made of a thermally conductive material, with the jacket including an end having an outer surface with a recessed portion;
a heating unit including a heating wire mounted inside the jacket or to an inner side of the jacket; and
a controller embedded in the recessed portion, with the controller electrically connected to the heating unit to control heating operation of the heating wire.

2. The heatable handle jacket as claimed in claim 1, with the controller including a protrusion, with the recessed portion including a wall having a groove, with the protrusion engaged in the groove of the recessed portion.

3. The heatable handle jacket as claimed in claim 2, with the controller including a temperature indicator, with the temperature indicator indicating a temperature of the heating wire, with the temperature indicator facing an opening of the recessed portion.

4. The heatable handle jacket as claimed in claim 1, with the jacket including an inner sleeve and an outer sleeve mounted around the inner sleeve, with the inner sleeve adapted to be mounted around the handle of the vehicle, with the outer sleeve made of the thermally conductive material, with the heating wire mounted between the inner and outer sleeves.

5. The heatable handle jacket as claimed in claim 4, with the heating wire extending helically around the inner sleeve.

6. The heatable handle jacket as claimed in claim 4, with the outer sleeve made of an elastomeric material.

7. The heatable handle jacket as claimed in claim 1, with the controller including a temperature indicator, with the temperature indicator indicating a temperature of the heating wire, with the temperature indicator facing an opening of the recessed portion.

8. The heatable handle jacket as claimed in claim 1, further comprising: a bonding layer filled between the controller and the recessed portion.
